(19) United States
(12) Patent Application Publication
(10) Pub. No.: US 2018/0075747 A1
(43) Pub. Date: Mar. 15, 2018

(54) SYSTEMS, APPARATUS, AND METHODS FOR IMPROVING SAFETY RELATED TO MOVABLE/ MOVING OBJECTS

(71) Applicant: Nodal Inc., Cambridge, MA (US)

(72) Inventor: Riju PAHWA, Cambridge, MA (US)

(21) Appl. No.: 15/499,738

(22) Filed: Apr. 27, 2017

Related U.S. Application Data
(63) Continuation of application No. PCT/US2015/058679, filed on Nov. 2, 2015.
(60) Provisional application No. 62/073,858, filed on Oct. 31, 2014.
(60) Provisional application No. 62/073,879, filed on Oct. 31, 2014.

(51) Int. Cl. G08G 1/16; G08G 1/0967; G08G 1/01

(52) U.S. Cl. CPC G08G 1/164; G08G 1/166; G01C 21/362; G08G 1/0141; G08G 1/0967

(57) ABSTRACT

Systems, apparatus, and methods for collecting, analyzing, and/or communicating information related to movable/moving objects are described. In some embodiments, a mobile computing device is configured to be carried by, attached to, and/or embedded within a moveable object. The device may include at least one communication interface, at least one output device, a satellite navigation system receiver, an accelerometer, at least one memory, and at least one processor for detecting the location, orientation, and/or motion of the moveable object. The information is compared to that of at least one other object and a likelihood of collision is predicted. If the predicted likelihood of collision is above a predetermined threshold, the mobile computing device outputs at least one of an audio indication, visual indication, and haptic indication to an operator of the moveable object.

### CROSS-REFERENCE TO RELATED APPLICATIONS

This application is a bypass continuation of International Application No. PCT/US2015/058679, filed on Nov. 2, 2015, entitled “Systems, Apparatus, And Methods For Improving Safety Related To Movable/Moving Objects,” which claims a priority benefit of U.S. Provisional Patent Application No. 62/073,858, filed on Oct. 31, 2014, entitled “System to Automatically Collect, Compute Characteristics of Individual Traffic Objects on Streets and Create Live GPS Feed,” and U.S. Provisional Patent Application No. 62/073,879, filed on Oct. 31, 2014, entitled “Apparatus to Automatically Collect Variety of Data About Cyclists, Pedestrians, Runners, and Vehicles on Streets and Compute, Calculate Accident Scores,” which applications are incorporated herein by reference in their entirety.

### TECHNICAL FIELD

The present disclosure relates generally to systems, apparatus, and methods for collecting, analyzing, and/or communicating information related to movable/moving objects. More specifically, the present disclosure relates to systems, apparatus, and methods for improving the safety of pedestrians, cyclists, drivers, and others involved with or affected by traffic by collecting, analyzing, and/or communicating information related to the traffic.

### BACKGROUND

The number of pedestrians and cyclists sharing the road with cars and trucks is growing in both suburban and urban environments, leading in some cases to higher numbers of accidents, injuries, and/or fatalities. For example, cities in the United States suffer over ten million accidents each year. Of these, over a million accidents involve pedestrians and/or cyclists. From an economic perspective, these accidents result in over one hundred billion dollars in expenses due to medical bills, personal and public property damage, municipal services, insurance premiums, absences from work, etc.

To better protect pedestrians and cyclists and promote alternative forms of transportation, local governments have been developing and constructing separate lanes or pathways for pedestrians and/or cyclists as well as implementing fixed traffic signals (e.g., at crosswalks) to caution vehicle operators to the potential presence of pedestrians and/or cyclists. Vehicle manufacturers are also developing and rolling out technology for accident prevention, including intelligent systems for detecting and reacting to nearby objects or phenomena.

### SUMMARY

With evolving urban environments and transportation options, local governments, private companies, vehicle operators, cyclists, pedestrians, and other stakeholders have an interest in proactive technologies for improved safety. Currently, cyclists, pedestrians, and similarly-situated individuals may feel and/or may be unseen, unheard, and therefore vulnerable in the current traffic environment. Such travelers are also at a disproportionately higher risk than vehicle operators of being injured in a traffic-related accident.

Governments have an interest in reducing traffic accidents and associated costs, promoting exercise-based transportation associated with a healthy lifestyle, and reducing vehicle congestion and associated carbon dioxide emissions. Governments may use predictive data about traffic accidents to improve public safety for residents. Governments also oversee vehicle operation (e.g., public transportation, school buses, etc.). Insurance companies also have an interest in managing accident risk and improving their profit margins by, for example, accessing individual's driving patterns, in some cases, in exchange for discounts on insurance premiums.

Of course, most vehicle operators and companies (e.g., delivery/distributors, rental agencies, car services, etc.) that utilize vehicular transportation also want to avoid accidents, keep costs low, reduce insurance premiums, and limit access by or reporting to insurance companies of individual driving patterns. Vehicle operators may be unaccustomed to changing traffic dynamics and/or frustrated by undisciplined cyclists, pedestrians, and other vehicle operators. Existing detection technologies, including semi-autonomous and/or autonomous vehicles, offer limited solutions with respect to cyclists and pedestrians and may be unavailable to the general public or require purchase of expensive luxury vehicles and/or accessories. Even these existing technologies have their limitations. For example, camera-based safety technologies work better during daylight hours than at night (when the majority of pedestrian deaths from car accidents occur).

Despite progress in the accuracy of detection algorithms, many situations remain in which sensors cannot differentiate between a real object of interest such as a cyclist and a moving shadow (e.g., of a building or tree). Environmental changes including moving shadows and weather phenomena (e.g., snow, rain, wind, etc.) may cause unusual and/or unpredictable scenarios leading to false positives and/or false negatives.

Sensors also may have range limitations, such as a fixed range (e.g., from few meters to hundreds of meters), and/or require a clear or substantially clear line of sight. As a result, an object (e.g., a cyclist) may be hidden behind another object (e.g., a bus), a curve in the road, and/or structure (e.g., a tall fence or building).

Timing is also important. In particular, for semi-autonomous and/or autonomous vehicles, early notifications are extremely important for auto-braking such that vehicles decelerate slowly without damaging any contents or injuring any passengers due to sudden stops. Early notifications may require situational awareness that goes beyond a few meters or even a few hundred meters. In situations where such a system does detect objects of interest accurately, it still lacks enough information about a detected object to optimize the processing, resulting in too much useless information. Thus, a system may be configured to conservatively notify a user of every single alert, or a system may be configured to notify a user of only higher priority alerts. However, even a sophisticated system would fail to account for a user's/object's ability to respond. For example, a pedestrian and a vehicle operator will have different notification preferences and/or response capabilities/behaviors. However, two vehicle operators also may have different notification preferences and/or response capabilities/behaviors based on age, health, and other factors.

Available media for communicating information to a vehicle operator may include visual, audio, and/or haptic aspects. For example, indicators may be installed on the dashboard, side mirror, seat, and steering wheel. Indicators may even be projected on part of the windshield. However, these indicators still require additional processing, resulting in delayed response times. Instead, indicators may be positioned to indicate more meaningful information (e.g., relative position of other traffic objects). For example, more of a windshield may be utilized to indicate, for example, a relative position of another traffic object. Vehicle operators, cyclists, and pedestrians may benefit from visual, audio, and/or haptic cues as to the presence of traffic and/or risks according to proximity/priority, relative position, etc. For example, wearables (e.g., implants, lenses, smartwatches, glasses, smart footwear, etc.) and/or other accessories may be used to communicate more meaningful information and thereby decrease response times.

One goal of the embodiments described herein is to change the transportation experience for everyone. In some embodiments, each traffic object, whether an ordinary, semi-autonomous, or fully-autonomous vehicle, cyclist, pedestrian, etc., is connected via a multi-sided network platform which provides realtime information about other traffic objects in order to mitigate the likelihood of accidents. In further embodiments, realtime data analytics may be derived from location-based intelligence, mapping information, and/or user behavior to notify users about their surroundings and potential risks (e.g., of collisions) with other users. In some embodiments, a user's smartphone and/or cloud-based algorithms may be used to generate traffic and/or safety intelligence.

In one embodiment, a mobile computing device to be at least one of carried by and attached to a bicycle includes at least one communication interface to facilitate communication via at least one network, at least one output device to facilitate control of the bicycle through at least one of audio, visual, and haptic indications, a satellite navigation system receiver to facilitate detection of a location of the bicycle, an accelerometer to facilitate detection of an orientation and a motion of the bicycle, at least one memory storing processor-executable instructions, and at least one processor communicatively coupled to the at least one communication interface, the at least one output device, the satellite navigation system, the accelerometer, and the at least one memory. Upon execution by the at least one processor of the processor-executable instructions, the at least one processor detects, via the satellite navigation system receiver, the location of the bicycle, detects, via the accelerometer, the orientation and the motion associated with the bicycle, and sends the location, the orientation, and the motion to a network server device over the at least one network, via the at least one communication interface. The network server device compares the location, the orientation, and the motion to information associated with at least one other traffic object to predict a likelihood of collision between the bicycle and the at least one other traffic object. If the predicted likelihood of collision is above a predetermined threshold, the mobile computing device receives a notification from the network server device over the at least one network, via the at least one communication interface, and outputs at least one of an audio indication, visual indication, and haptic indication to a cyclist operating the bicycle, via the at least one output device.

In one embodiment, a first network computing device to be at least one of carried by, attached to, and embedded within a first movable object includes at least one communication interface to facilitate communication via at least one network, at least one output device to facilitate control of the first movable object, at least one sensor to facilitate detecting of at least one of a location, an orientation, and a motion associated with the first movable object, at least one memory storing processor-executable instructions, and at least one processor communicatively coupled to the at least one memory, the at least one sensor, and the at least one communication interface. Upon execution by the at least one processor of the processor-executable instructions, the at least one processor detects, via the at least one sensor, at least one of a first location, a first orientation, and a first motion associated with the first movable object, and sends to a second network computing device over the at least one network, via the at least one communication interface, at least one of the first location, the first orientation, and the first motion associated with the first movable object such that the second network computing device compares at least one of the first detected location, the first detected orientation, and the first detected motion to at least one of a second location, a second orientation, and a second motion associated with a second movable object to determine a likelihood of collision between the first movable object and the second movable object. If the likelihood of collision is above a predetermined threshold, the first network computing device receives over the at least one network, via the at least one communication interface, an alert from the second network computing device, and outputs the alert, via the at least one output device, to an operator of the first movable object.

In one embodiment, a first network computing device to be at least one of carried by, attached to, and embedded within a first movable object includes at least one communication interface to facilitate communication via at least one network, at least one output device to facilitate control of the first movable object, at least one sensor to facilitate detecting of at least one of a location, an orientation, and a motion associated with the first movable object, at least one memory storing processor-executable instructions, and at least one processor communicatively coupled to the at least one memory, the at least one sensor, and the at least one communication interface. Upon execution by the at least one processor of the processor-executable instructions, the at least one processor detects, via the at least one sensor, at least one of a first location, a first orientation, and a first motion associated with the first movable object, receives from a second network computing device over the at least one network, via the at least one communication interface, at least one of a second location, a second orientation, and a second motion associated with a second movable object, compares at least one of the first detected location, the first detected orientation, and the first detected motion to at least one of the second location, the second orientation, and the second motion to determine a likelihood of collision between the first movable object and the second movable object, and if the likelihood of collision is above a predetermined threshold, sends an alert over the at least one network, via the at least one communication interface, to the second network computing device, and outputs the alert, via the at least one output device, to an operator of the first movable object.

In one embodiment, a method of using a first network computing device to avoid a traffic accident, the first network computing device being at least one of carried by, attached to, and embedded within a first movable object, includes detecting, via at least one sensor in the first network computing device, at least one of a first location, a first orientation, and a first motion associated with the first movable object, receiving from a second network computing device over at least one network, via at least one communication interface in the first network computing device, at least one of a second location, a second orientation, and a second motion associated with a second movable object, comparing, via at least one processor in the first network computing device, at least one of the first detected location, the first detected orientation, and the first detected motion to at least one of the second location, the second orientation, and the second motion to determine a likelihood of collision between the first movable object and the second movable object, and if the likelihood of collision is above a predetermined threshold, sending an alert over the at least one network, via the at least one communication interface, to the second network computing device, and outputting the alert, via at least one output device in the first network computing device, to an operator of the first movable object.

In an embodiment, the second network computing device is at least one of carried by, attached to, and embedded within the second movable object. In an embodiment, the at least one sensor includes at least one of a satellite navigation system receiver, an accelerometer, a gyroscope, and a digital compass.

In one embodiment, a network system for preventing traffic accidents includes at least one communication interface to facilitate communication via at least one network, at least one memory storing processor-executable instructions, and at least one processor communicatively coupled to the at least one memory and the at least one communication interface. Upon execution by the at least one processor of the processor-executable instructions, the at least one processor receives at least one of a first location, a first orientation, and a first motion associated with a first movable object over the at least one network, via the at least one communication interface, from a first network computing device, the first network computing device being at least one of carried by, attached to, and embedded within the first movable object, receives at least one of a second location, a second orientation, and a second motion associated with a second movable object over the at least one network, via the at least one communication interface, from a second network computing device, the second network computing device being at least one of carried by, attached to, and embedded within the second movable object, compares at least one of the first detected location, the first detected orientation, and the first detected motion to at least one of the second location, the second orientation, and the second motion to determine a likelihood of collision between the first movable object and the second movable object, and if the likelihood of collision is above a predetermined threshold, sends an alert over the at least one network, via the at least one communication interface, to the first network computing device and the second network computing device for action by at least one of a first operator of the first movable object and a second operator of the second movable object.

In one embodiment, a method for preventing traffic accidents includes receiving at least one of a first location, a first orientation, and a first motion associated with a first movable object over the at least one network, via at least one communication interface, from a first network computing device, the first network computing device being at least one of carried by, attached to, and embedded within the first movable object, receiving at least one of a second location, a second orientation, and a second motion associated with a second movable object over the at least one network, via the at least one communication interface, from a second network computing device, the second network computing device being at least one of carried by, attached to, and embedded within the second movable object, comparing, via at least one processor, at least one of the first detected location, the first detected orientation, and the first detected motion to at least one of the second location, the second orientation, and the second motion to determine a likelihood of collision between the first movable object and the second movable object, and if the likelihood of collision is above a predetermined threshold, sending an alert over the at least one network, via the at least one communication interface, to the first network computing device and the second network computing device for action by at least one of a first operator of the first movable object and a second operator of the second movable object.

In an embodiment, the first moveable object is at least one of a vehicle, a cyclist, and a pedestrian. In an embodiment, the second moveable object is at least one of a vehicle, a cyclist, and a pedestrian.

In one embodiment, a vehicle traffic alert system includes a display for alerting vehicles to a presence of at least one of a cyclist and a pedestrian, a wireless communication interface for connecting the display via at least one network to a computing device at least one of carried by, attached to, and embedded within the at least one of the cyclist and the pedestrian to collect and transmit real-time data regarding at least one of a location, an orientation, and a motion associated with the at least one of the cyclist and the pedestrian, and a control module for activating the display based on the at least one of the location, the orientation, and the motion associated with the at least one of the cyclist and the pedestrian, whereby the vehicle traffic alert system controls the display autonomously by transmissions to and from the display and the computing device.

In one embodiment, a vehicle traffic control system includes intersection control hardware at an intersection for preemption of traffic signals, a wireless communication interface for connecting the intersection control hardware via at least one network to a computing device at least one of carried by, attached to, and embedded within at least one of a cyclist and a pedestrian to collect and transmit real-time data regarding an intersection status and at least one of a location, an orientation, and a motion associated with the at least one of the cyclist and the pedestrian, and an intersection control module for actuating and verifying the preemption of traffic signals based on the intersection status and the at least one of the location, the orientation, and the motion associated with the at least one of the cyclist and the pedestrian, whereby the vehicle traffic alert system controls the preemption of traffic signals at the intersection autonomously by transmissions to and from the intersection control hardware and the computing device.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, processes, and features will become apparent to those skilled in the art upon examination of the following drawings and detailed description. It is intended that all such additional systems, processes, and features be included within this description, be within the scope of the present invention, and be protected by the accompanying claims.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a flow chart illustrating systems, apparatus, and methods for improving the safety of pedestrians, cyclists, and drivers by collecting, analyzing, and/or communicating information related to traffic in accordance with some embodiments.

FIG. 2 is a user display illustrating an interface for notifying a vehicle operator of movable/moving objects based on the proximity of the movable/moving objects to the vehicle in accordance with some embodiments.

FIG. 3 is a user display illustrating an interface for selecting a mode in accordance with some embodiments.

FIG. 4 is a user display illustrating an interface for using a map mode in accordance with some embodiments.

FIG. 5 is a user display illustrating an interface for using a ride mode in accordance with some embodiments.

FIG. 6 is a user display illustrating an interface for alerting a user in ride mode in accordance with some embodiments.

FIG. 7 is a user display illustrating an interface for setting user preferences in accordance with some embodiments.

FIG. 8 is a user display illustrating an alternative interface for using a map mode in accordance with some embodiments.

FIG. 9 is a user display illustrating an interface for using a drive mode in accordance with some embodiments.

FIG. 10 is a user display illustrating an interface for receiving scoring information associated with cycling in accordance with some embodiments.

FIG. 11 is a user display illustrating an alternative interface for receiving scoring information associated with driving a vehicle in accordance with some embodiments.

FIG. 12 is a user display illustrating an interface for reviewing information associated with previous travel in accordance with some embodiments.

FIG. 13 is a diagram illustrating a right cross scenario in which a vehicle and a bicycle are traveling perpendicular on track for collision in accordance with some embodiments.

FIG. 14 is a diagram illustrating a safe cross scenario in which a vehicle and a bicycle are traveling perpendicular but will not collide in accordance with some embodiments.

FIG. 15 is a diagram illustrating a dooring scenario in which a vehicle is parked on the side of a road and a bicycle attempts to pass the vehicle in accordance with some embodiments.

FIG. 16 is a diagram illustrating a right hook scenario in which a vehicle is waiting to turn right at an intersection and a bicycle attempts to travel through the intersection from the same direction in a right bike lane in accordance with some embodiments.

FIG. 17 is a diagram illustrating a left cross scenario in which a vehicle is waiting to turn left at an intersection and a bicycle attempts to travel through the intersection from the opposite direction in a right bike lane in accordance with some embodiments.

FIG. 18 is a perspective view illustrating a cycling device for collecting, analyzing, and/or communicating information in accordance with some embodiments.

FIG. 19 is a perspective view illustrating a vehicle-integrated interface for indicating presence of a cyclist to a vehicle operator in accordance with some embodiments.

FIG. 20 is a perspective view illustrating an alternative vehicle-integrated interface for indicating presence of a cyclist to a vehicle operator in accordance with some embodiments.

FIG. 21 is a perspective view illustrating an interface for indicating presence of a cyclist in accordance with some embodiments.

### DETAILED DESCRIPTION

The present disclosure relates generally to systems, apparatus, and methods for collecting, analyzing, and/or communicating information related to movable/moving objects. More specifically, the present disclosure relates to systems, apparatus, and methods for improving the safety of pedestrians, cyclists, drivers, and others involved with or affected by traffic by collecting, analyzing, and/or communicating information related to the traffic.

In some embodiments, a network platform (accessed using, e.g., a mobile software application) connects all users whether a user is a vehicle operator, cyclist, pedestrian, etc. The platform may be used to monitor and outsmart dangerous traffic situations. One or more algorithms (e.g., cloud-based) may be applied based on both historic and realtime analytics derived based on location, routing information, and/or behavior associated with one or more users to determine one or more risk scores and to intelligently notify at least one user about a potentially dangerous situation. If the user is using a mobile software application to access the network platform, mobile device (e.g., smartphone, fitness device, and smartwatch) sensors and associated data may be combined with data from other sources (e.g., satellite systems, traffic systems, traffic signals, smart bikes, surveillance cameras, traffic cameras, inductive loops, and maps) to predict potential accidents.

The platform may provide a user with different kinds of customizable notifications to indicate realtime information about other users in the user's vicinity. For example, the platform may warn a user of a hazard using visual, audio, and/or haptic indications. If the user is using a mobile software application to access the network platform, a notification may take the form of a visual alert (e.g., an overlay on a navigation display). A notification may be hands-free (e.g., displayed on a screen or projected on a surface) or even eyes-free (e.g., communicated as one or more audio and/or haptic indications). For example, a cyclist or runner may select to receive only audio and haptic notifications.

Embodiments may be used by or incorporated into high-tech apparatus, including, but not limited to, vehicles, bicycles, wheelchairs, and/or mobile electronic devices (e.g., smartphones, tablets, mapping/navigation devices/consoles, vehicle telematics/safety devices, health/fitness monitors/pedometers, microchip implants, assistive devices, Internet of Things (IoT) devices, etc.). Embodiments also may be incorporated into various low-tech apparatus, including, but not limited to, mobility aids, strollers, toys, backpacks, footwear, and pet leashes.

Embodiments may provide multiple layers of services, including, but not limited to, secure/encrypted communications, collision analysis, behavior analysis, reporting analysis, and recommendation services. The data collected and analyzed may include, but is not limited to, location information, behavioral information, activity information, as well as realtime and historical records/patterns associated with collisions, weather phenomena, maps, traffic signals, IoT devices, etc. Predictions may be made with varying degrees of confidence and reported to users, thereby enhancing situational awareness.

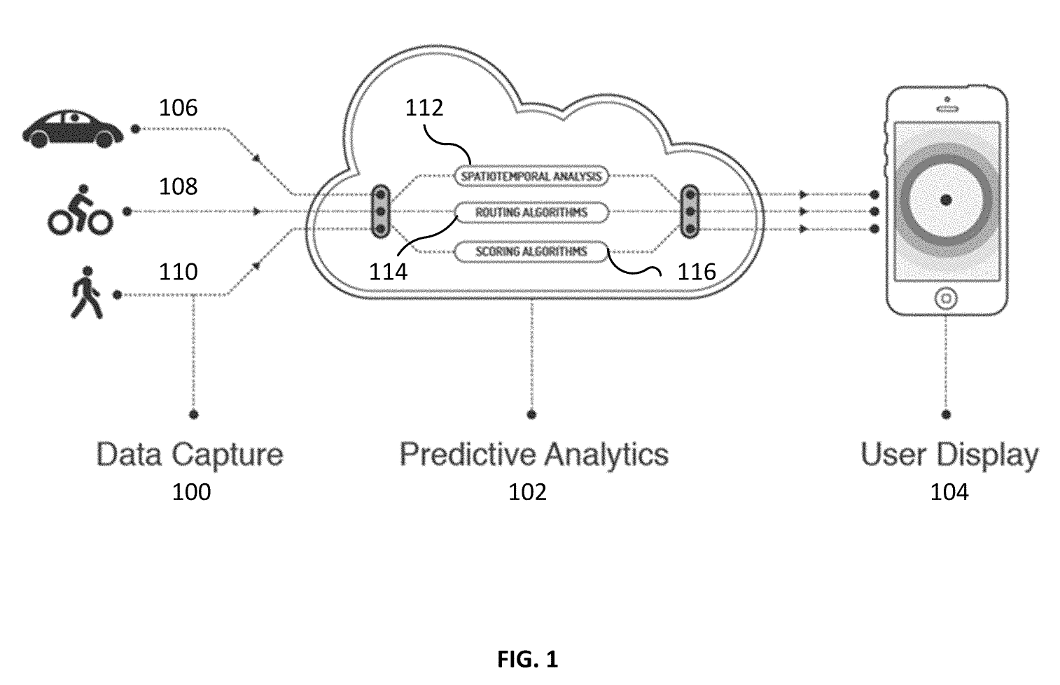

FIG. 1 is a flow chart illustrating systems, apparatus, and methods for improving the safety of pedestrians, cyclists, and drivers by collecting, analyzing, and/or communicating information related to traffic in accordance with some embodiments. Steps may include capturing data 100, applying predictive analytics to the captured data 102, and/or communicating (e.g., displaying) the results to a user 104.

In step 100, data may captured from a variety of sources including, but not limited to, movable/moving objects, such as vehicle operators 106, cyclists 108, and pedestrians 110. A movable/moving object also may include a vehicle or mobile machine that transports people and/or cargo, including, but not limited to, a bicycle, a motor vehicle (e.g., a car, truck, bus, or motorcycle), a railed vehicle (e.g., a train or tram), a watercraft, an aircraft, and a spacecraft. A movable/moving object may include a movable/moving autonomous or semi-autonomous subject, including, but not limited to, a human pedestrian (e.g., a person traveling on foot, riding in a stroller, skating, skiing, or using a wheelchair), an animal (e.g., domesticated, captive-bred, or wild), and a semi-autonomous or autonomous vehicle or other machine. A movable/moving object further may include natural or man-made matter, including, but not limited to, weather phenomena and debris.

In step 100, data may captured from a variety of sources including, but not limited to, movable/moving objects, such as vehicle operators 106, cyclists 108, and pedestrians 110. A movable/moving object also may include a vehicle or mobile machine that transports people and/or cargo, including, but not limited to, a bicycle, a motor vehicle (e.g., a car, truck, bus, or motorcycle), a railed vehicle (e.g., a train or tram), a watercraft, an aircraft, and a spacecraft. A movable/moving object may include a movable/moving autonomous or semi-autonomous subject, including, but not limited to, a human pedestrian (e.g., a person traveling on foot, riding in a stroller, skating, skiing, or using a wheelchair), an animal (e.g., domesticated, captive-bred, or wild), and a semi-autonomous or autonomous vehicle or other machine. A movable/moving object further may include natural or man-made matter, including, but not limited to, weather phenomena and debris.

### Data Capture

In some embodiments, realtime location data and/or spatial information about traffic objects are collected. Each object may be tracked individually—including the object's type (e.g., vehicle, bicycle, pedestrian, etc.), speed, route, and/or dimensions. That information may be related to other spatial information, such as street location, street geometry, and businesses, houses, and/or other landmarks near each object.

Remote sensing technologies may allow a vehicle to acquire information about an object without making physical contact with the object, and may include radar (e.g., conventional or Doppler), light detection and ranging (LIDAR), and cameras, and other sensory inputs. Although remote sensing information may be integrated with some embodiments, the realtime location data and/or spatial information described herein may offer 360 degree detection and operate regardless of weather or lighting conditions. For example, in embodiments used by or incorporated within a mobile device (e.g., a smartphone or navigation system), a user may leverage satellite technology (e.g., existing GNSS/GPS access) for realtime location data and/or spatial information that enables vehicle operators, cyclists, pedestrians, etc., to connect with each other, increase their visibility to others, and/or receive alerts regarding dangerous scenarios.

In embodiments used by or incorporated within a mobile device (e.g., a smartphone or navigation system), a user may leverage existing sensors to collect information. These sensors may include, but are not limited to, an accelerometer, a magnetic sensor, and a gyrometer. For example, an accelerometer may be used to collect individual angular and speed data about a traffic object or an operator of a traffic object to determine if the object or the operator is sitting, walking, running, or cycling. In some embodiments, the angle of the accelerometer is used to determine whether a sitting object/operator is sitting straight, upright, or relaxed. In some embodiments, more than one accelerometer (e.g., in multiple smartphones) may be moving at roughly the same speed and around the same spatial coordinates, indicating that multiple traffic objects are traveling together or one traffic object has more than one user associated (e.g., multiple smartphone users are inside the object).

Behavior can be an important factor in traffic safety. For example, weather, terrain, and commuter patterns affect behavior as do individual factors. Some key behavioral factors associated with crashes include the influence of drugs, caffeine, and/or alcohol; physical and/or mental health (e.g., depression); sleep deprivation and/or exhaustion; age and/or experience (e.g., new drivers); distraction (e.g., texting); and eyesight. These factors may affect behavior in terms of responsiveness, awareness, multi-tasking ability, and/or carelessness or recklessness.

TABLE 1 lists some reported behaviors that have led to collisions between vehicles and cyclists in Boston, Mass., according to their frequency over the course of one recent year.

TABLE 1

| Behavior | Frequency |
|---|---|
| Driver did not see cyclist | 156 |
| Cyclist rode into oncoming traffic | 108 |
| Cyclist ran red light | 85 |
| Cyclist was speeding | 57 |
| Cyclist did not see driver | 41 |
| Driver was speeding | 24 |
| Driver ran red light | 23 |
| Cyclist ran stop sign | 22 |
| Driver ran stop sign | 17 |
| Cyclist has a personal item caught | 2 |

### Predictive Analytics

Statistical analytics may be based on maps, traffic patterns (e.g., flow graphs and event reports), weather patterns, and/or other historical data. For example, traffic patterns may be identified and predicted based on, for example, the presence or absence of blind turns, driveways, sidewalks, crosswalks, curvy roads, and/or visibility/light.

Streaming analytics may be based on realtime location/terrain, traffic conditions, weather, social media, information regarding unexpected and/or hidden traffic objects (in motion), and/or other streaming data.

According to some embodiments, a network platform consists of two modules capable of processing at over a billion transactions per second. First, a historic data module derives insights from periodically ingested data from multiple sources such as Internet images (e.g., Google Street View™ mapping service), traffic and collision records, and urban mapping databases that include bike and pedestrian friendly paths. Second, a realtime data module analyzes realtime information streams from various sources including network accessible user devices, weather, traffic, and social media. Predictive capabilities may be continuously enhanced using guided machine learning.

In some embodiments, an accident or collision score representing a probability of an accident or collision is predicted and/or reported. Other scores that may be predicted and/or reported may include, but are not limited to, a congestion score representing a probability and/or magnitude of traffic congestion, a street score representing a quality (e.g., based on safety) of a street for a particular type of traffic object (e.g., runner), a neighborhood score representing a quality of an area for a particular type of traffic object, and a traffic object score (e.g., a driver or cyclist score) representing a quality of an object's movement/navigation.

### Collision Scores

In some embodiments, information is used to generate an accident or collision score based on the trajectories of two or more traffic objects. The accident or collision score may be modeled as a function inversely proportional to distance, visibility, curviness, speed, lighting, and/or other factors. A higher score at a given location indicates a higher likelihood of collision between the objects at the given location.

For example, collision score (C) may be a function of one or more of the direct and derived inputs listed in TABLE 2 in accordance with some embodiments.

TABLE 2

| Input | Symbol |
|---|---|
| Distance between the objects | d |
| Angle between the objects | a |
| Geometry of the path (e.g., curvy, blind turn, | g |
| straight) | |
| Presence of bike lanes (or sidewalks) | bl |
| Sensing capabilities within the objects (e.g., | sc |
| radar, LIDAR, camera) | |
| Time of the day | t |
| Day of the year | d |
| Location (e.g., latitude/longitude) and/or | l |
| location-based intelligence | |
| Object types (e.g., runner, wheelchair | ot |
| pedestrian, cyclist, or vehicle) | |
| Object sensor types (e.g., carried, | ost |
| attached/wearable, or embedded/implanted) | |
| Object velocities | ov |
| If vehicle, vehicle types (e.g., economy car, | vt |
| SUV, bus, motorcycle, trailer) | |
| If vehicle, vehicle velocities | vv |
| If vehicle, vehicle owners (e.g., taxi, fleet, | vw |
| consumer) | |
| Vehicle data (e.g., effectiveness of braking | cd |
| and other health conditions available through | |
| the vehicle's on-board diagnostics port) | |

The purpose of collision score C is to determine a probability of a first object O₁ colliding with a second object O₂ at a given location under the current conditions:

C(O₁,O₂)=f(d,a,g,bl,sc,t,d,l,ot,ost,ov,vt,vv,vw,cd) (1)

In a given situation, the score C may be modeled using four vectors: (1) risk of collision (RC); (2) time to potential collision (T), which may include a range [min,max] and/or a mean±standard deviation); (3) visibility (V); and (4) impact of potential collision (I).

For example, consider Scenario 1, in which a passenger vehicle is approaching a cyclist at a distance of 50 meters (d=50 m), at a turn with a turn radius of 10 meters, on an urban city road with a speed limit of 30 mph or 48.2 km/hr (g) at a speed of 80.4 km/hr (vv=80.4) thus creating a visibility challenge. The street does have bike lanes (bl=1), but the car is not equipped with any Advanced Driver Assistance System (ADAS) or other sensor capabilities (ost=0). It is a weekend, that is, Sunday at 9:00 PM at night (t) in September (d).

Stopping sight distance (ssd) is the sum of the reaction distance and the breaking distance, and may be estimated using the formula:

ssd=0.278(Vv)(t)+0.039(Vv)^{2/a}, (2)

where Vv is the design speed (e.g., 30 mph or 48.2 km/hr in Scenario 1), t is the perception/reaction time (e.g., 2.5 seconds is selected for Scenario 1), and a is the deceleration rate (e.g., 3.4 m/s² is selected for Scenario 1). Thus, the stopping sight distance ssd is 60.2 meters in Scenario 1.

The risk of collision RC is directly proportional to the deviation from safe distance:

RC∝K₁(1+% deviation)=K₁(1+(ssd−d)/d), (3)

such that the risk of collision RC is proportional to K₁*1.2 in Scenario 1.

The street curve radius (rad) impacts visibility (V), which may be estimated using the formula:

V=rad(1−cos(28.65ssd/rad)), (4)

such that the visibility V is about 13.9 meters, that is, a sharp turn with very poor visibility, in Scenario 1.

The presence of bike lanes (bl=1) has been shown to reduce the probability of accidents by about 53%. As in some embodiments, this may be modeled as:

RC∝K₂(1−0.53), (5)

such that the risk of collision RC is proportional to K₂*0.47 in Scenario 1.

The presence of ADAS has been shown to reduce the probability of accidents by about 28% to about 67%. As in some embodiments, this may be modeled as:

RC ∝K₃(1−0.28), (6)

however, risk of collision RC remains proportional to K₃ in Scenario 1 because no ADAS is present.

The probability of a collision at night time has been shown to be about double the probability of a collision during the day. As in some embodiments, this may be modeled as:

RC ∝K₄(1.92), (7)

such that the risk of collision RC is proportional to K₄*1.92 in Scenario 1.

The probability of a collision on a weekend day has been shown to be about 19% higher than the probability of a collision on a weekday. As in some embodiments, this may be modeled as:

RC ∝K₅(1.19), (8)

such that the risk of collision RC is proportional to K₅*1.19 in Scenario 1.

In the United States, September has been shown to have the highest rate of fatal collisions compared to other months of the year. The range of rates varies from 2.20 in September to 1.98 in February and March, with a mean of 2.07 and standard deviation of approximately 6%. As in some embodiments, this may be modeled as:

RC ∝K₆(1.06), (9)

such that the risk of collision RC is proportional to K₆*1.06 in Scenario 1.

The rate of collisions in an urban environment has been shown to be twice as high as the rate of collisions in a rural environment. As in some embodiments, this may be modeled as:

RC ∝K₇(2), (10)

such that the risk of collision RC is proportional to K_{T}*2 in Scenario 1.

Passenger vehicles have been shown to have a higher crash frequency (e.g., 14% higher) per 100 million miles traveled than trucks (light and heavy). As in some embodiments, this may be modeled as:

RC ∝K₈(1.14), (11)

such that the risk of collision RC is proportional to K₈*(1.14) in Scenario 1.

In Scenario 1, the vehicle velocity vv is 80 km/hr on a road with a speed limit of 48.2 km/hr (Vv). As in some embodiments, this may be modeled as:

$$RC ∝ {K}_{9} ( \frac{1}{{e}^{( 6 , 9 - 0.09 Vv )}} ) , \qquad ( 12 )$$

such that the risk of collision RC is proportional to K₉*(1.42) in Scenario 1.

The impact of potential collision I may be estimated using the formula:

$$I = \frac{1}{2} {M ( vv )}^{2} / d , \qquad ( 13 )$$

where an average mass M of a car may be estimated as 1452 pounds and an average mass M of a truck may be estimated as 2904 pounds, such that the impact of potential collision I is 7280.33N in Scenario 1, based on a vehicle velocity vv is 80 km/hr and a mass M of 1452 pounds.

Time to potential collision may be estimated using the formula:

T=d/vv, (14)

where the time to potential collision is 2.23 seconds in Scenario 1.

Based on the above observations and calculations:

RC ∝1.2*K₁*0.47*K₂*1*K₃*1.92*K₄*1.19*K₅*1.01*K₆*2*K₇*1.14*K₈*1.42*K₉ (15)

such that the risk of collision RC is about 4.40*K in Scenario 1, where:

K=K₁*K₂*K₃*K₄*K₅*K₆*K₇*K₈*K₉ (16)

As in some embodiments, these expressions may be used to model the risk of collision RC for other scenarios by varying the inputs. Examples are listed in TABLE 3 according to some embodiments.

TABLE 3

| | Condition Set | | | | |
|---|---|---|---|---|---|
| | (d, rad, bl, adas, time, day, month, road type, | | | | |
| # | vehicle type, vehicle velocity) | RC | T (s) | V (m) | I (N) |
| 2 | 50, 15, bl = yes, adas = no, night, weekend, | 4.634 | 2.23 | 13.90 | 7280.00 |
| | September, urban, passenger, 80 | | | | |
| 3 | 100, 50, bl = yes, adas = Yes, day, weekend, | 0.129 | 6.00 | 99.20 | 2017.22 |
| | August, urban, passenger, 60 | | | | |
| 4 | 65, 20, bl = no, adas = no, day, weekday, August, | 0.276 | 4.25 | 28.58 | 5214.74 |
| | Urban, truck, 55 | | | | |
| 5 | 40, 22, bl = yes, adas = no, night, weekday, April, | 8.774 | 1.60 | 42.23 | 22664.00 |
| | Urban, truck, 90 | | | | |
| 6 | 40, 40, bl = no, adas = no, day, weekday, July, | 3.053 | 1.92 | 18.63 | 7879.77 |
| | Urban, passenger, 75 | | | | |
| 7 | 30, 40, bl = no, adas = yes, day, weekend, | 0.588 | 1.96 | 18.60 | 5650.00 |
| | October, Urban, passenger, 55 | | | | |
| 8 | 25, 10, bl = yes, adas = no, night, weekday, | 0.420 | 1.87 | 16.30 | 5207.20 |
| | September, Urban, passenger, 48.2 | | | | |

### Behavioral Scores

In some embodiments, information is used to generate a behavioral score (B). For example, using technology capabilities of mobile devices like smartphones and fitness monitors as well as data from the Internet, a rich set of information may be obtained for understanding human behavior. In some embodiments, one or more algorithms are applied to gauge the ability of a traffic object/operator to navigate safely.

For example, behavioral score (B) may be a function of one or more of the direct and derived inputs listed in TABLE 4 in accordance with some embodiments.

TABLE 4

| Input | Symbol |
|---|---|
| Under the influence of drugs | id |
| Under the influence of caffeine | cf |
| Under the influence of alcohol | ia |
| Depressed | dp |
| Sleep deprived | sd |
| Physically exhausted | pe |
| Sick | s |
| Distracted (e.g., texting) | otp |
| Has compromised eyesight | es |
| Is senior or lacks experience (e.g., new | a |
| driver) | |

The purpose of behavioral score B is to determine if a traffic object/operator O is compromised in any way that may pose a danger to the traffic object/operator or others:

C(O)=f(id,cf,ia,dp,sd,pe,s,otp,es,a) (17)

In a given situation, the score B may be modeled based on: (1) responsiveness or perception-brake reaction time (Rs); (2) awareness to surroundings or time to fixate (Aw); and (3) ability to multi-task (Ma), for example, handling multiple alerts at substantially the same time.

For example, reconsider Scenario 1, in which the passenger vehicle is approaching the cyclist. In addition to the previous information from calculating the collision score, the operator of the passenger vehicle is a young driver (a) who smoking cigarettes (id) but is not under the influence of alcohol (ia) or caffeine (cf) and mentally stable (dp). The driver also is frequently checking his email while driving (otp). By capturing information and combining it with data from his smartphone regarding his sleeping habits, alarm settings, phone and Internet usage, etc., it is predicted that the driver is also sleep deprived (sd).

According to some embodiments, the driver's responsiveness Rs may be measured as the time to respond (e.g., brake) to a stimulus, and driver's awareness Aw may be measured as the time to fixate on a stimulus.

Drug use may affect responsiveness. For example, thirty minutes of smoking cigarettes with 3.9% THC has been shown to reduce responsiveness by increasing response times by about 46%. As in some embodiments, this may be modeled as:

Rs=β₁*id, (18)

such that the responsiveness Rs (time to respond) is proportional to β₁*1.46 in Scenario 1.

A shot of caffeine has been shown to reduce response times in drivers by 13%. Two shots of caffeine have been shown to reduce response times by 32%. As in some embodiments, this may be modeled as:

Rs=β₂*cf (19)

however, the driver is not caffeinated so the responsiveness Rs is proportional to β₂*1 in Scenario 1.

Alcohol has been shown to reduce response rates by up to 25% as well as awareness or visual processing (e.g., up to 32% more time to process visual cues). As in some embodiments, this may be modeled as:

Rs=β₃_{_}₁*ia, and (20)

Aw=β₃_{_}₂*ia, (21)

however, the driver is not under the influence of alcohol so the responsiveness Rs is proportional to β₃_{_}₁*1, and the awareness Aw is proportional to β₃_{_}₂*1 in Scenario 1.

Depression and other mental health issues may interfere with people's ability to perform daily tasks. There is a positive correlation between depression and the drop in ability to operate motor vehicle safely. For example, a 1% change in cognitive state has been shown to result in a 6% drop in ability to process information, which translates into a 6% slower response time. As in some embodiments, this may be modeled as:

Rs=β₄*dp, (22)

however, the driver is not depressed so the responsiveness Rs is proportional to β₄*1 in Scenario 1.

Sleep deprivation and fatigue have been shown to reduce a person's reaction time or response time by over 15%. As in some embodiments, this may be modeled as:

Rs=β₅*sd, (23)

such that the driver's responsiveness Rs is proportional to β₅*1.15 in Scenario 1.

Seniors have been shown to take up to 50% more time to get a better sense of awareness or to fixate on a stimulus. As in some embodiments, this may be modeled as:

Aw=β₆*a, (24)

however, the driver is younger so the awareness Aw is proportional to β₆*1 in Scenario 1.

Distractions like using a phone while driving have been shown to reduce a driver's ability to respond quickly. For example, the probability of a collision has been shown to increase 2% to 21%. As in some embodiments, this may be modeled as:

Aw=β₇*otp, (25)

such that the driver's awareness Aw is proportional to β₇*1.1 in Scenario 1.

Based on the above observations and calculations:

Rs ∝β₁*β₂*β₃_{_}₁*β₄*β₅*id*cf*ia*dp*sd, (26)

such that the driver's responsiveness Rs is about 1.679*β in Scenario 1, where:

β=β₁*β₂*β₃_{_}₁*β₄*β₅, and (27)

Aw ∝β₃_{_}₂*sd*a, (28)

such that the driver's awareness Aw is about 1.5*6 in Scenario 1, where:

δ=β₃_{_}₂ (29)

As in some embodiments, these expressions may be used to model other scenarios by varying the inputs. Examples are listed in TABLE 5 according to some embodiments.

TABLE 5

| | | | Condition | |
|---|---|---|---|---|
| # | Condition Set (id, cf, ia, dp, sd) | Rs | Set (a, otp) | Aw |
| 2 | No, single, no, yes, no | β * .92 | older, no | ∂ * 1.5 |
| 3 | No, none, yes, no, yes | β * 1.4 | older, yes | ∂ * 2.1 |
| 4 | No, double, no, no, yes | β * .782 | young, yes | ∂ * 1.21 |
| 5 | Yes, none, yes, yes, yes | β * 2.224 | young, yes | ∂ * 1.45 |
| 6 | No, none, yes, no, no | β * 1.06 | older, no | ∂ * 1.5 |
| 7 | No, single, no, yes, no | β * .92 | young, yes | ∂ * 1.1 |

### Reporting Scores

In some embodiments, information is used to generate a reporting score (R). The purpose of reporting score R is to determine at what point and how a traffic object/operator should be notified of a risky situation such as a potential collision. Reporting score R may help to avoid information overload by minimizing notifications that could be considered false positives (i.e., information of which a traffic object/operator is already aware or does not want to receive). Reporting score R also may help by minimizing notifications that could be considered false negatives due to detection challenges associated with sensor-based detection. In addition, the reporting score R may capture user preferences and/or patterns regarding format and effectiveness of notifications.

The reporting system may include visual, audio, and/or haptic notifications. For example, a vehicle operator may be notified through lights (e.g., blinking), surface projections, alarms, and/or vibrations (e.g., in the steering wheel). Cyclists and pedestrians may be notified through lights (e.g., headlight modulations, alarms, and/or vibrations (e.g., in a smartwatch or fitness monitor)

In some embodiments, a reporting system may take into account at least one of: (1) automatic braking capabilities in a traffic object; (2) remote control capabilities in a traffic object (e.g., a semi-autonomous or autonomous vehicle that can be controlled remotely); and (3) traffic object/operator preferences.

For example, reporting score (R) may be a function of one or more of the traffic object/operator preferences listed in TABLE 6 in accordance with some embodiments.

TABLE 6

| Preference | Symbol |
|---|---|
| Notifications enabled | ne |
| Collision notification frequency | nf |
| Collision notification severity threshold | ns |
| Notification type (e.g., visual, audio, haptic) | nt |
| Notification direction (two-way, object-to- | nd |
| vehicle, vehicle-to-object) | |

In some embodiments, reporting score R may interrelate with a first traffic object/operator's behavioral score B(O₁), a collision score C(O₁, O₂) between the first traffic object and a second traffic object, and/or a machine-based learning factor, such as the first traffic object/operator's patterns of alertness and preferences:

R(O₁,O₂)=f(ne,nf,ns,nt,nd,B,C) (30)

In a given situation, the score R may be modeled based on three vectors: (1) a reporting sequence (Seq); (2) an effectiveness of a reporting sequence (Eff); and (3) a delegation of control of a traffic object to ADAS or remote control (Dctrl).

For example, reconsider Scenario 1, in which the passenger vehicle is approaching the cyclist. In addition to the previous information from calculating the collision score and the behavioral score of the driver, the operator of the passenger vehicle has enabled safety notifications through his smartphone and haptic notifications through his smart watch. The cyclist also has enabled haptic notifications on her smartwatch. Thus the reporting system has been enabled for two-way safety notifications.

Safety notifications have been shown to reduce the risk of collisions up to 80%. As in some embodiments, this may be modeled as:

Eff ∝Ω₁*ne, (31)

such that the effectiveness Eff is proportional to Ω₁*1.8 since the driver enabled notifications in his smartphone in Scenario 1.

Audio, visual, and haptic notifications have been shown to have different levels of effectiveness. For example, audio reports have been shown to be most effective with a score of 3.9 out of 5, visual being 3.5 out of 5, and haptic being 3.4 out of 5. As in some embodiments, this may be modeled as:

Eff ∝Ω₂*nt, (32)

such that the effectiveness Eff is proportional to Ω₂*3.9 since the driver enabled audio notifications in his smartphone in Scenario 1.

Because the cyclist in Scenario 1 enabled haptic notifications on her smartwatch, the system has two-way notification. As in some embodiments, this may be modeled as:

Eff ∝Ω₃*nd, (33)

such that the effectiveness Eff is proportional to Ω₃*1.8 in Scenario 1.

Based on the previously calculated collision score vector:

Eff ∝Ω₄*C[4.63412292316303,13.9788126377374,2.23325062034739,7280.33430864197] (34)

Based on the previously calculated behavioral score vector:

Eff ∝Ω₅*B[1.679,1.1] (35)

Based on the above observations and calculations:

Eff ∝1.8*Ω₁*3.9*Ω₂*1.8*Ω₃*1.92*Ω₄*Ω₅*C[4.63412292316303,13.9788126377374,2.23325062034739,7280.33430864197]*B[1.679,1.1] (36)

or:

Eff=Ω*12.636*C[4.63412292316303,13.9788126377374,2.23325062034739,7280.33430864197]*B[1.679,1.1] (37)

The new collision score C may be represented as:

Ω₆*[4.63412292316303,13.9788126377374,2.23325062034739,7280.33430864197] (38)

The new behavioral score B may be represented as:

Ω₇*[1.679,1.1] (39)

The decision to delegate control Dctrl may be represented as:

Ω₈*Eff (40)

As in some embodiments, these expressions may be used to model other scenarios by varying the inputs. Examples are listed in TABLE 7 according to some embodiments.

TABLE 7

| | Condition Set (ne, rs, nd, C[ ], | |
|---|---|---|
| # | B[ ]) | Eff |
| 2 | Yes, visual, one-way(v-b), | Ω * 6.3 * C[cond.set.2], |
| | C[cond.set.2], R[cond.set.2] | R[cond.set.2] |
| 3 | Yes, none, no notifications, | Ω * 1 * C[cond.set.3], |
| | C[cond.set.3], R[cond.set.3] | R[cond.set.3] |
| 4 | Yes, haptic, two-way(v-b-v), | Ω * 11.016 * C[cond.set.4], |
| | C[cond.set.4], R[cond.set.4] | R[cond.set.4] |
| 5 | Yes, audio, two-way(v-b), | Ω * 12.636 * C[cond.set.5], |
| | C[cond.set.5], R[cond.set.5] | R[cond.set.5] |
| 6 | Yes, audio, one-way(v-b), | Ω * 7.02 * C[cond.set.6], |
| | C[cond.set.6], R[cond.set.6] | R[cond.set.6] |

### User Interfaces

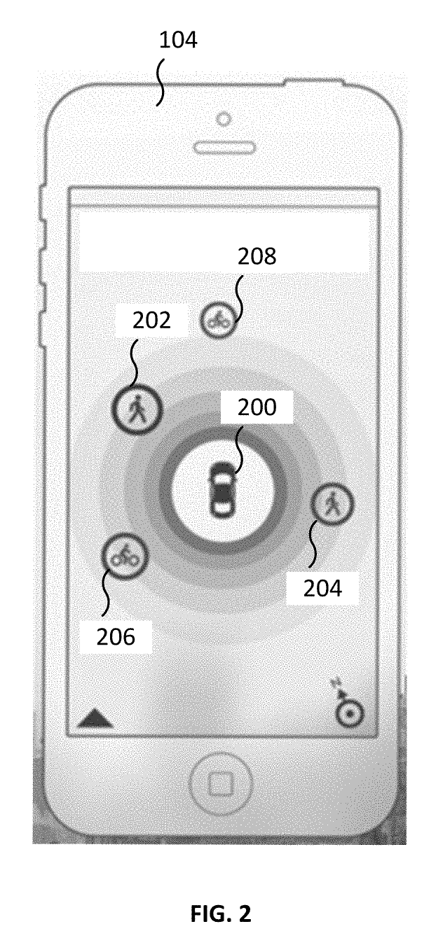

According to some embodiments, a user (e.g., a traffic object/operator) is provided with one or more user interfaces to receive information about other users that are not visible to the user but with whom the user has a potential for collision. This information is translated from the collision or accident scores calculated above to a user as visual, audio, and/or haptic content. For example, the information may be displayed to the user via a display screen on the user's smartphone or car navigation system. FIG. 2 is a user display illustrating an interface for notifying a vehicle operator of movable/moving objects based on collision scores of the movable/moving objects to the vehicle in accordance with some embodiments.

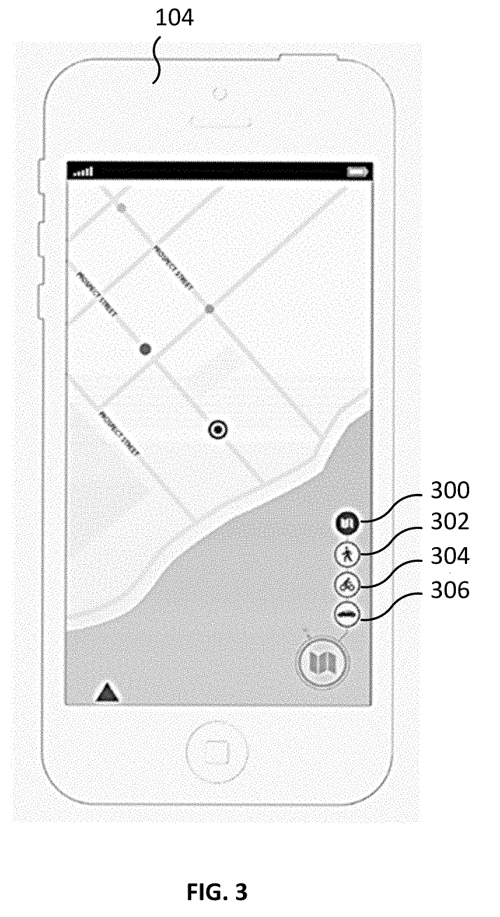

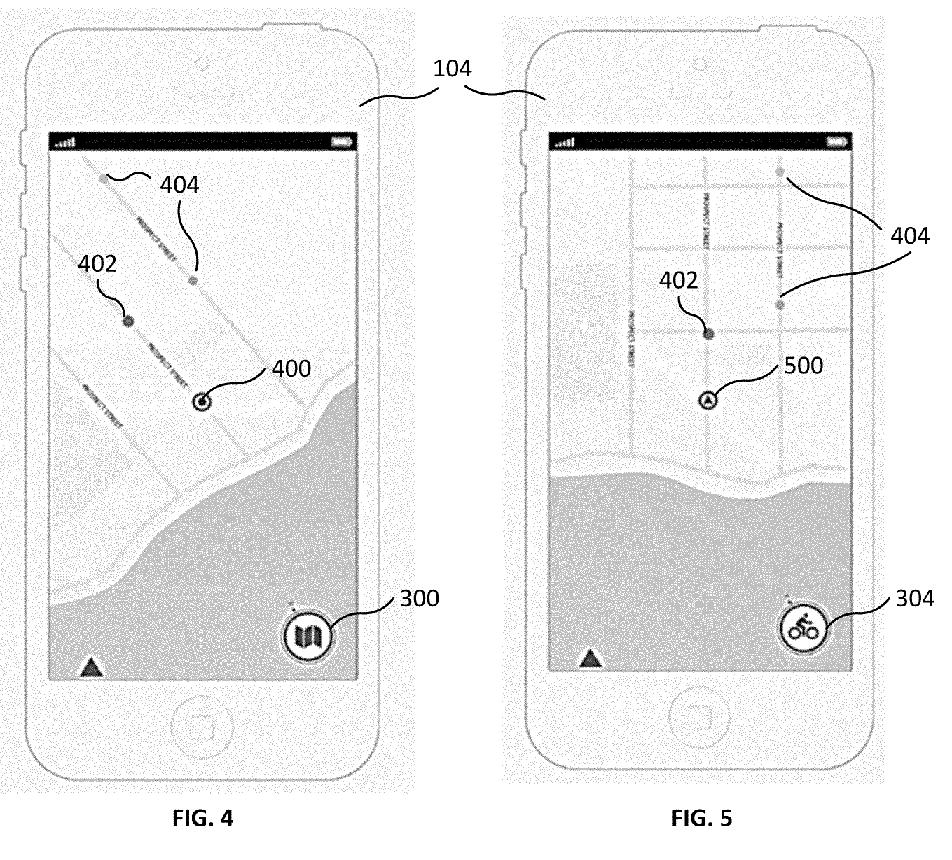

FIG. 3 is a user display illustrating an interface for selecting a mode in accordance with some embodiments. FIG. 4 is a user display illustrating an interface for using a map mode in accordance with some embodiments. In some embodiments, object details are overlaid on a map (e.g., satellite imagery). Movement of the objects relative to the map may be shown in realtime. The type of object, dimensions, density, and other attributes may be used to determine whether or not to display a particular object. For example, if one hundred cyclists are passing within 100 meters of a vehicle, the system may intelligently consolidate the cyclists into a group object and visualize with one group object. On the other hand if only one cyclist is within 100 meters of the vehicle, the system may accurately visualize that object on the user interface.

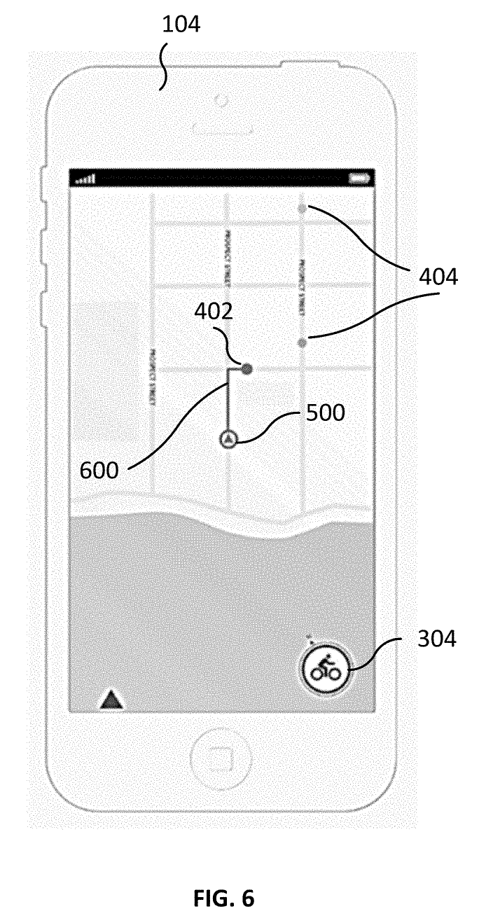

FIG. 5 is a user display illustrating an interface for using a ride mode in accordance with some embodiments. FIG. 6 is a user display illustrating an interface for alerting a user in ride mode in accordance with some embodiments. As long as a device is connected to the network and, for example, the mobile software application is running in the background (even if not the primary application at the time), notifications may continue to be provided. In some embodiments, an autonomous or semi-autonomous sensing and notification platform connects users (e.g., drivers, cyclists, pedestrians, etc.) in realtime. For example, a user may notify and caution other users along their route or be notified and cautioned.

According to researchers, the number one reason why more people don't bike, run, or walk outside is fear of being hit by a vehicle. In the United States, a cyclist, runner, or pedestrian ends up in an emergency room after a collision or other dangerous interaction with a vehicle every thirty seconds. As density in urban and suburban areas increases, this issue is likely to get worse.

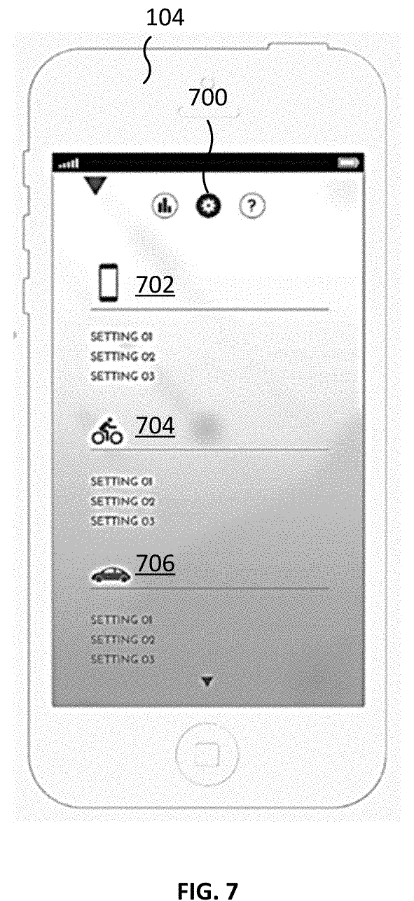

Better data yields smarter (and safer) routes. For example, recommendations may be based on historical and realtime data including evolving crowd intelligence, particular user patterns/preferences, traffic patterns, and the presence of paths, bike lanes, crosswalks, etc. In some embodiments, an analytics platform encourages cyclists, runners, and other pedestrians to easily access safe-route information for their outdoor activities. The result is that users are facilitated to make safer path choices based on timing, location, route, etc. In addition to safety, the platform may offer personalized recommendations based on scenic quality, weather, shade, popularity, air quality, elevation, traffic, etc. FIG. 7 is a user display illustrating an interface for setting user preferences in accordance with some embodiments.

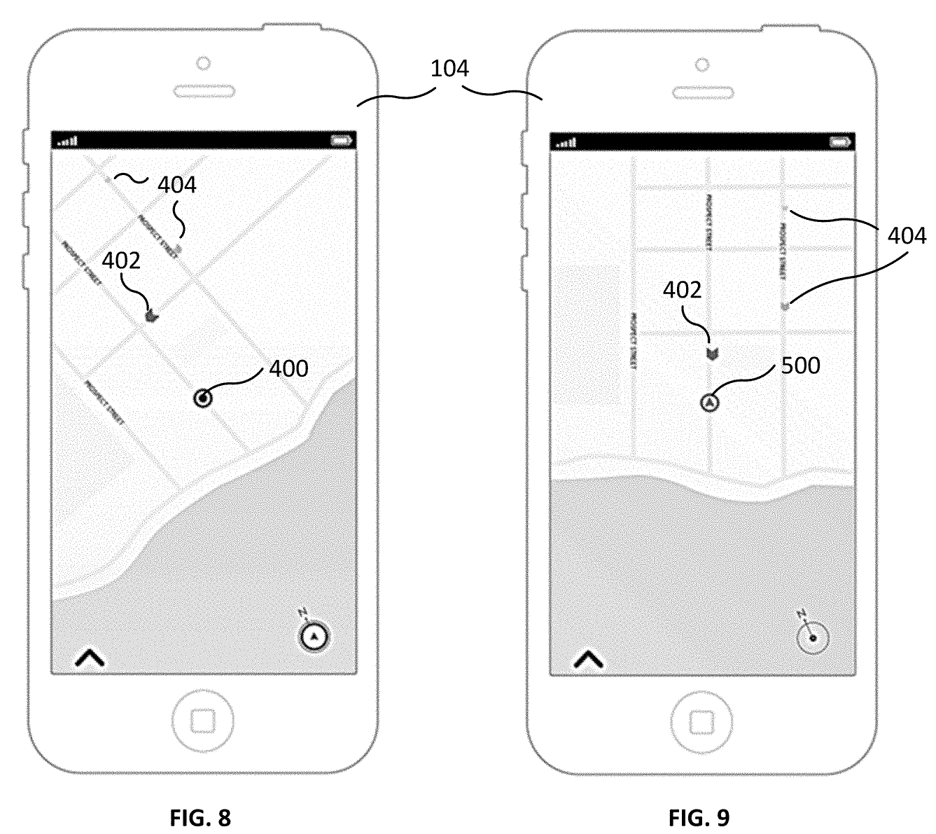

FIG. 8 is a user display illustrating an alternative interface for using a map mode in accordance with some embodiments. FIG. 9 is a user display illustrating an interface for using a drive mode in accordance with some embodiments.

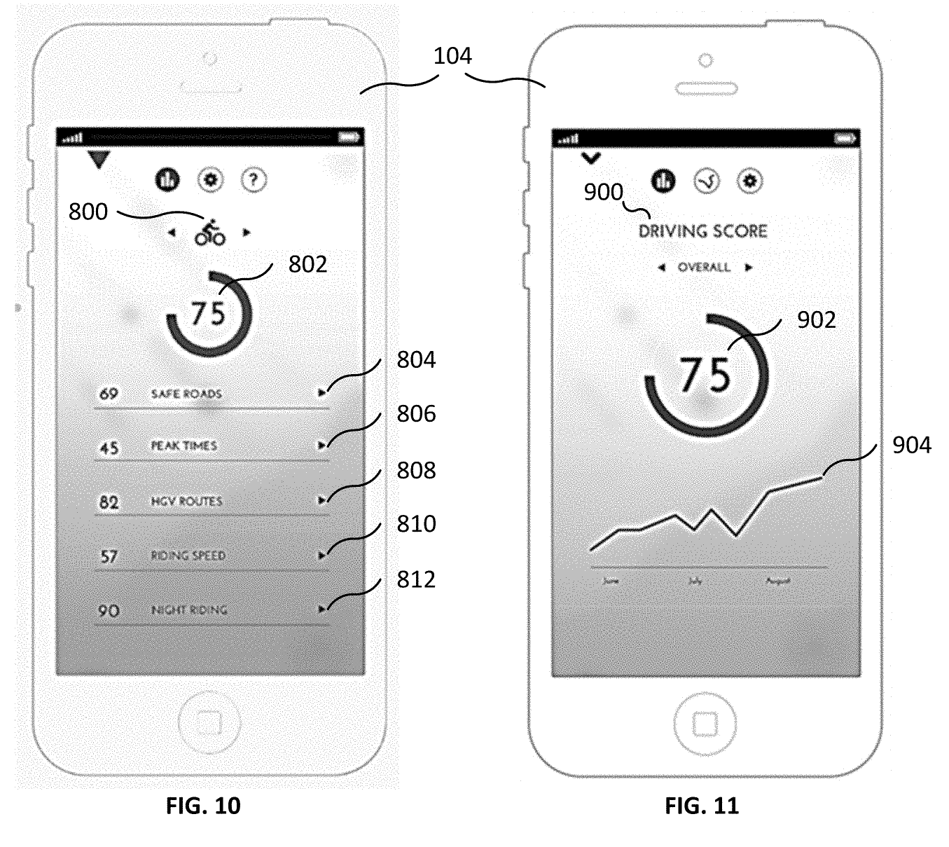

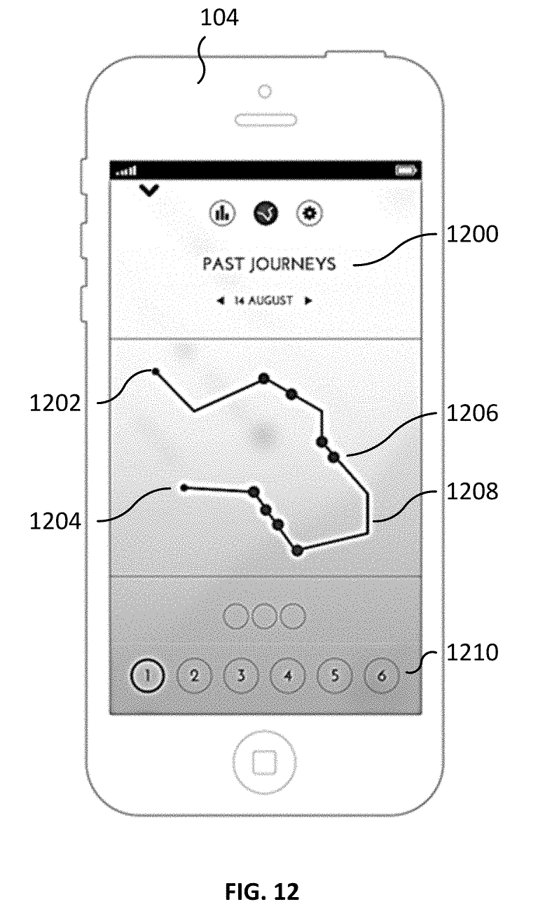

FIG. 10 is a user display illustrating an interface for receiving scoring information associated with cycling in accordance with some embodiments. FIG. 11 is a user display illustrating an alternative interface for receiving scoring information associated with driving a vehicle in accordance with some embodiments. FIG. 12 is a user display illustrating an interface for reviewing information associated with previous travel in accordance with some embodiments.

In some embodiments, data analytics may be provided to, for example, municipalities (e.g., for urban planning and traffic management) and/or insurance companies. Third parties may be interested in, for example, usage of different types of traffic objects, realtime locations, historical data, and alerts. These inputs may be analyzed to determine common routes and other patterns for reports, marketing, construction, and/or other services/planning.

In some embodiments, notifications may include automatic or manual requests for roadside assistance. In some embodiments, accident (e.g., collisions or falls) may be automatically detected, and emergency services and/or predetermined emergency contacts may be notified.

In some embodiments, one or more control centers may be used for realtime monitoring. Realtime displays may alert traffic objects/operators about the presence of other traffic objects/operators or particular traffic objects. For example, special alerts may be provided when semi-autonomous and/or autonomous vehicles are present. In some embodiments, manual monitoring and control of a (semi-)autonomous vehicle may be enabled, particularly in highly ambiguous traffic situations or challenging environments. The scores may be monitored continuously such that any need for intervention may be determined. Constant two-way communication may be employed between the vehicle and a control system that is deployed in the cloud. The human acts as a “backup driver” in case both the vehicle's autonomous system and the safety system fail to operate the vehicle above a threshold confidence level.

According to some embodiments, real time scoring architecture may allow communities to create both granular and coarse scoring of streets, intersections, turns, parking, and other infrastructure. Different scoring ranges or virtual zones may be designated friendly for particular types of traffic objects. For example, certain types of traffic objects (e.g., semi- or fully-autonomous vehicles, cyclists, pedestrians, pets, etc.) may be encouraged or discouraged from certain areas. Secure communication may be used between the infrastructure and traffic objects, enabling an object to announce itself, handshake, and receive approval to enter a specific zone in realtime. The scores as defined above may change in realtime, and zoning may change as a result. For instance, the zoning scores and/or fencing may be used to accommodate cyclist and pedestrian traffic, school hours, and other situations that may make operations of certain objects more challenging in an environment.

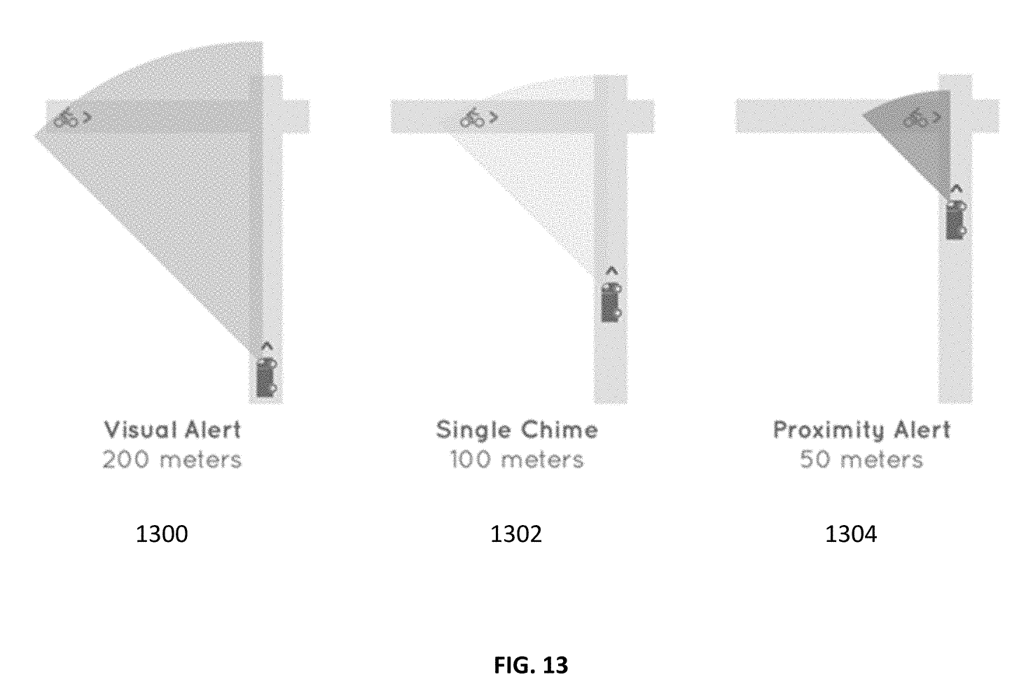

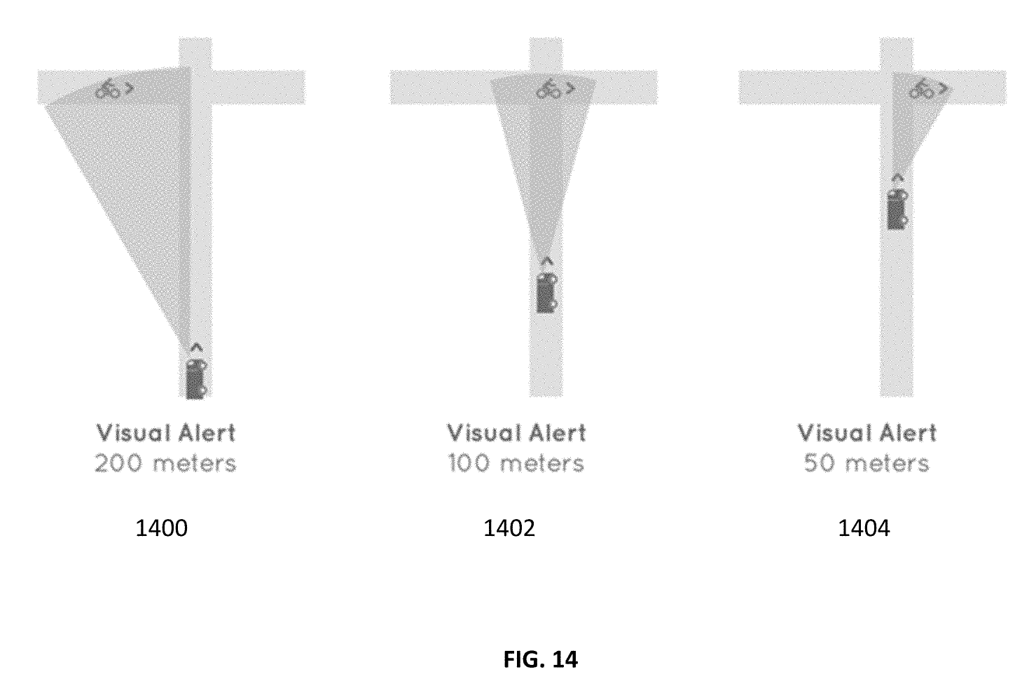

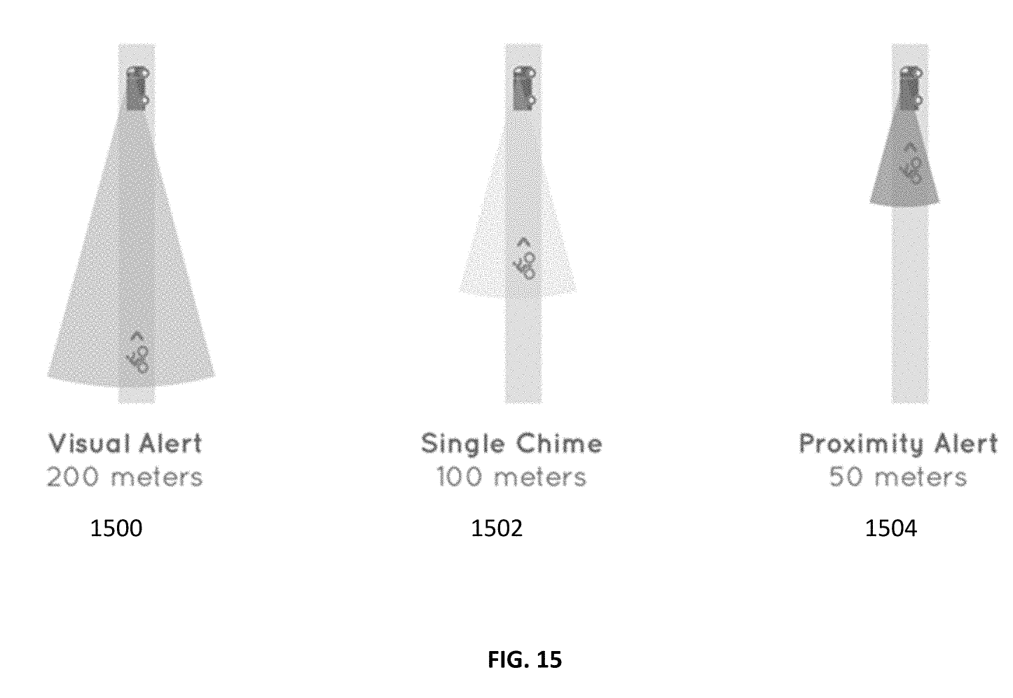

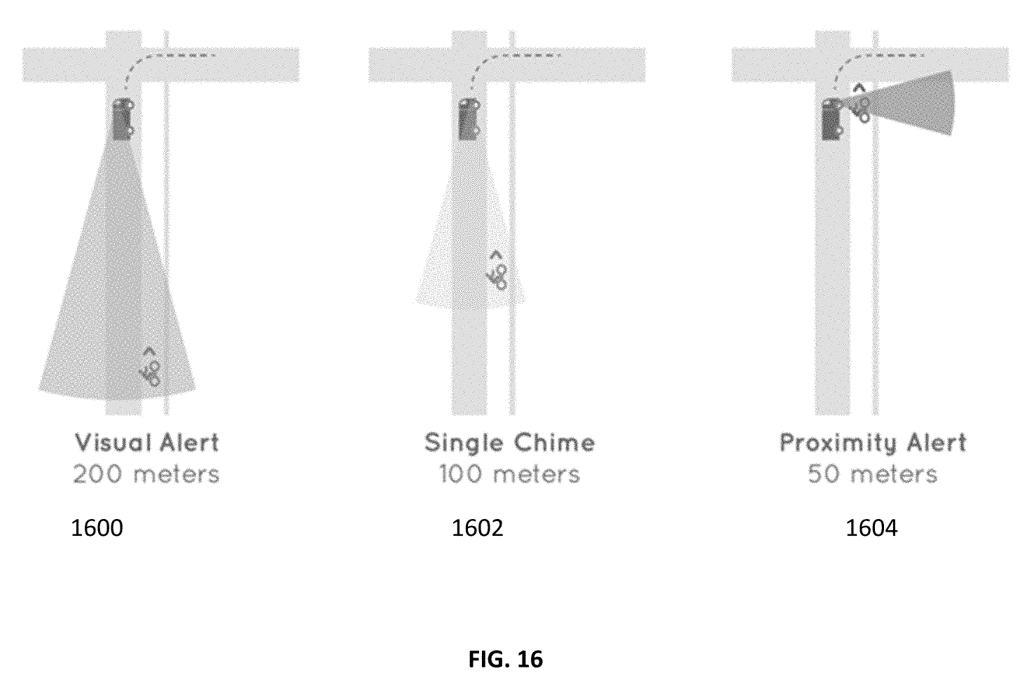

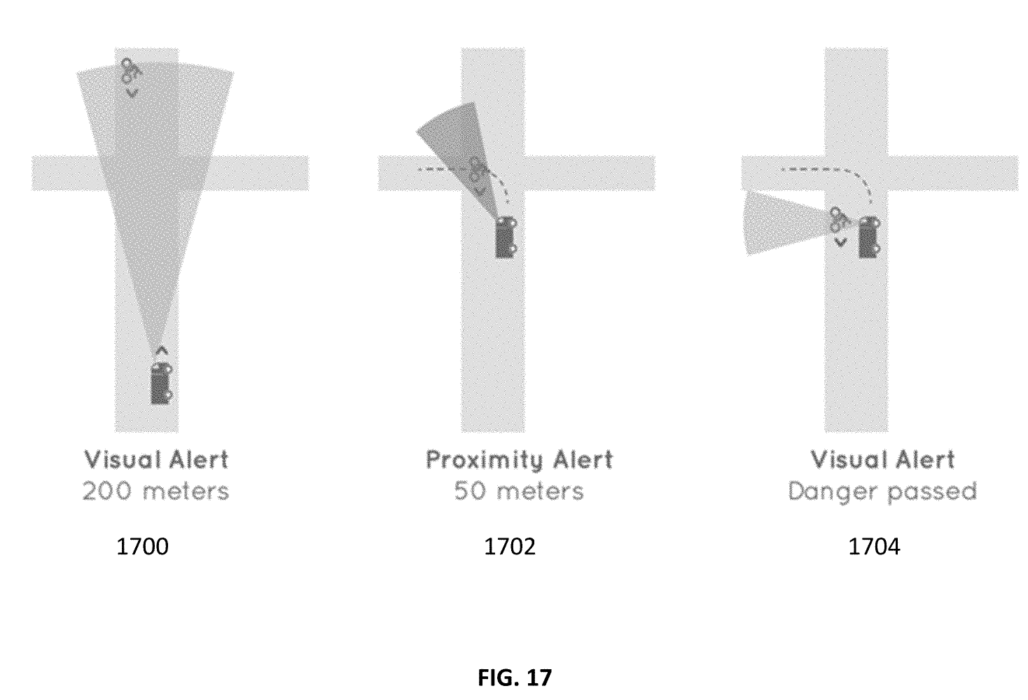

FIGS. 13-17 provide examples of some scenarios in which the risk of a collision is high along with notification sequences in accordance with some embodiments. For example, FIG. 13 is a diagram illustrating a right cross scenario in which a vehicle and a bicycle are traveling perpendicular on track for collision in accordance with some embodiments. FIG. 14 is a diagram illustrating a safe cross scenario in which a vehicle and a bicycle are traveling perpendicular but will not collide in accordance with some embodiments. FIG. 15 is a diagram illustrating a dooring scenario in which a vehicle is parked on the side of a road and a bicycle attempts to pass the vehicle in accordance with some embodiments. FIG. 16 is a diagram illustrating a right hook scenario in which a vehicle is waiting to turn right at an intersection and a bicycle attempts to travel through the intersection from the same direction in a right bike lane in accordance with some embodiments. FIG. 17 is a diagram illustrating a left cross scenario in which a vehicle is waiting to turn left at an intersection and a bicycle attempts to travel through the intersection from the opposite direction in a right bike lane in accordance with some embodiments.

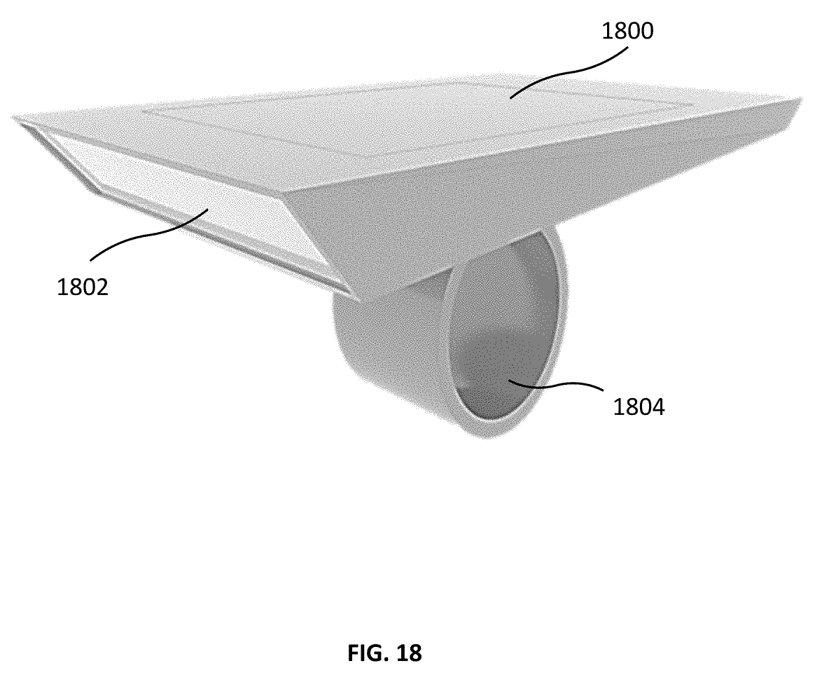

Some embodiments are incorporated into a vehicle or a smart bicycle or an accessory or component thereof. For example, FIG. 18 is a perspective view illustrating a cycling device for collecting, analyzing, and/or communicating information in accordance with some embodiments. The device may include a display 1800 to show ride characteristics and/or vehicle alerts. The device may include a communication interface for wirelessly communicating with a telecommunications network or another local device (e.g., with a smartphone over Bluetooth®). The device may be locked and/or capable of locking the bicycle. The device may be unlocked using a smartphone. The device may include four high power warm white LEDs 1802 (e.g., 428 lumens)—two LEDs for near field visibility (e.g., 3 meters) and two for far field visibility (e.g., 100 meters). The color tone of the LEDs may be selected to be close to the human eye's most sensitive range of wavelengths. The device may be configured to self-charge one or more batteries during use so that a user need not worry about draining or recharging the one or more batteries.

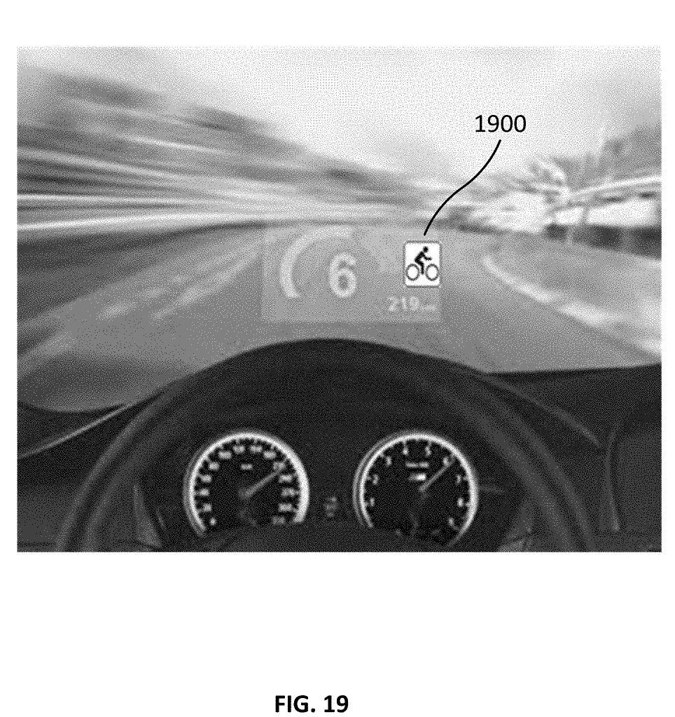

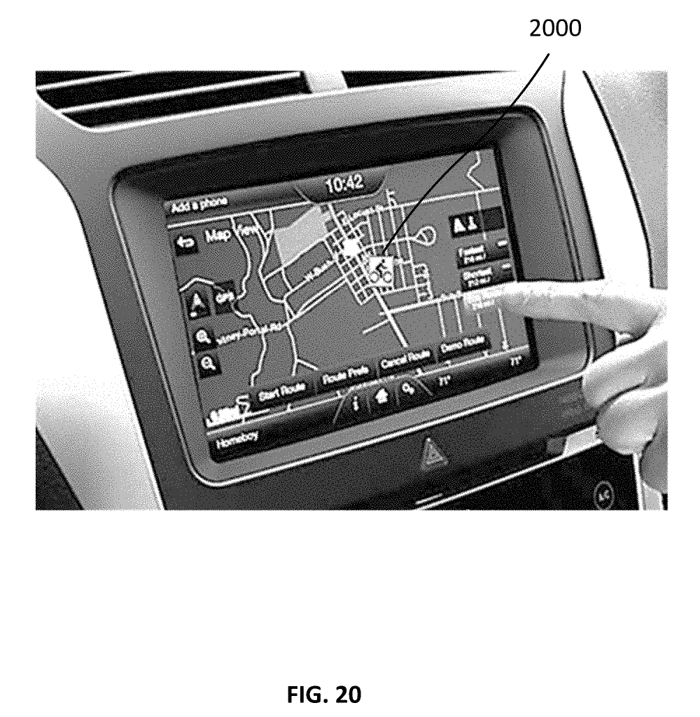

FIG. 19 is a perspective view illustrating a vehicle-integrated interface for indicating presence of a cyclist to a vehicle operator in accordance with some embodiments. FIG. 20 is a perspective view illustrating an alternative vehicle-integrated interface for indicating presence of a cyclist to a vehicle operator in accordance with some embodiments.

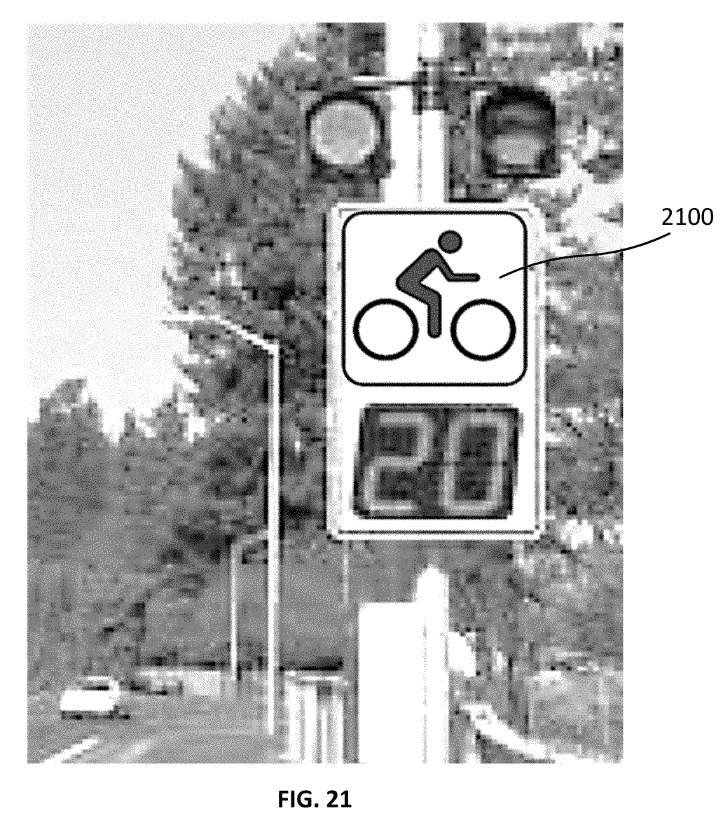

In some embodiments, a user interface includes one or more variable messaging signs on the street. FIG. 21 is a perspective view illustrating an interface for indicating presence of a cyclist in accordance with some embodiments.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A mobile computing device to be at least one of carried by and attached to a bicycle, the mobile computing device comprising:
at least one communication interface to facilitate communication via at least one network;
at least one output device to facilitate control of the bicycle through at least one of audio, visual, and haptic indications;
a satellite navigation system receiver to facilitate detection of a location of the bicycle;
an accelerometer to facilitate detection of an orientation and a motion of the bicycle;
at least one memory storing processor-executable instructions; and
at least one processor communicatively coupled to the at least one communication interface, the at least one output device, the satellite navigation system, the accelerometer, and the at least one memory, wherein upon execution by the at least one processor of the processor-executable instructions, the at least one processor:
detects, via the satellite navigation system receiver, the location of the bicycle;
detects, via the accelerometer, the orientation and the motion associated with the bicycle;
sends the location, the orientation, and the motion to a network server device over the at least one network, via the at least one communication interface, such that the network server device compares the location, the orientation, and the motion to information associated with at least one other traffic object to predict a likelihood of collision between the bicycle and the at least one other traffic object;
if the predicted likelihood of collision is above a predetermined threshold, receives a notification from the network server device over the at least one network, via the at least one communication interface; and
outputs at least one of an audio indication, visual indication, and haptic indication to a cyclist operating the bicycle, via the at least one output device.

2. A first network computing device to be at least one of carried by, attached to, and embedded within a first movable object, the first network computing device comprising:
at least one communication interface to facilitate communication via at least one network;
at least one output device to facilitate control of the first movable object;
at least one sensor to facilitate detecting of at least one of a location, an orientation, and a motion associated with the first movable object;
at least one memory storing processor-executable instructions; and
at least one processor communicatively coupled to the at least one memory, the at least one sensor, and the at least one communication interface, wherein upon execution by the at least one processor of the processor-executable instructions, the at least one processor:
detects, via the at least one sensor, at least one of a first location, a first orientation, and a first motion associated with the first movable object;
sends to a second network computing device over the at least one network, via the at least one communication interface, at least one of the first location, the first orientation, and the first motion associated with the first movable object such that the second network computing device compares at least one of the first detected location, the first detected orientation, and the first detected motion to at least one of a second location, a second orientation, and a second motion associated with a second movable object to determine a likelihood of collision between the first movable object and the second movable object;
if the likelihood of collision is above a predetermined threshold, receives over the at least one network, via the at least one communication interface, an alert from the second network computing device; and
outputs the alert, via the at least one output device, to an operator of the first movable object.

3. (canceled)

4. A method of using a first network computing device to avoid a traffic accident, the first network computing device being at least one of carried by, attached to, and embedded within a first movable object, the method comprising:
detecting, via at least one sensor in the first network computing device, at least one of a first location, a first orientation, and a first motion associated with the first movable object;
receiving from a second network computing device over at least one network, via at least one communication interface in the first network computing device, at least one of a second location, a second orientation, and a second motion associated with a second movable object;
comparing, via at least one processor in the first network computing device, at least one of the first detected location, the first detected orientation, and the first detected motion to at least one of the second location, the second orientation, and the second motion to determine a likelihood of collision between the first movable object and the second movable object; and
if the likelihood of collision is above a predetermined threshold,
sending an alert over the at least one network, via the at least one communication interface, to the second network computing device; and
outputting the alert, via at least one output device in the first network computing device, to an operator of the first movable object.

5. The first network computing device or method of claim 4, wherein the second network computing device is at least one of carried by, attached to, and embedded within the second movable object.

6. The first network computing device or method of claim 4, wherein the at least one sensor includes at least one of:
a satellite navigation system receiver;
an accelerometer;
a gyroscope; and
a digital compass.

7. (canceled)

8. (canceled)

9. (canceled)

10. (canceled)

11. (canceled)

12. (canceled)
